(19) United States
(12) Patent Application Publication
(10) Pub. No.: US 2008/0175727 A1
(43) Pub. Date: Jul. 24, 2008

(54) Electromagnetic displacement control valve in clutchless type variable displacement compressor

(76) Inventors: Satoshi Umemura, Kariya-shi (JP); Tatsuya Hirose, Kariya-shi (JP); Yuji Hashimoto, Kariya-shi (JP); Kazutaka Oda, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 12/004,151

(22) Filed: Dec. 19, 2007

(30) Foreign Application Priority Data
Dec. 20, 2006 (JP) 2006-343343

(51) Int. Cl. F04B 49/22; F16K 31/02

(52) U.S. Cl. 417/307; 251/129.01

(57) ABSTRACT

An electromagnetic displacement control valve in a clutchless type variable displacement compressor is disclosed. The control valve includes a valve body, an electromagnetic driving device, a buffer spring, and an urging spring. The electromagnetic driving device drives the valve body toward a position for closing the valve hole. The buffer spring urges the valve body toward the position for closing the valve hole. The urging spring urges the valve body in a direction away from the position for closing the valve hole against an elastic urging force of the buffer spring. In a state where no current is supplied to the electromagnetic driving device, the valve body is capable of moving in a direction away from the position for closing the valve hole against the elastic urging force of the buffer spring.

### BACKGROUND OF THE INVENTION

The present invention relates to an electromagnetic displacement control valve in a clutchless type variable displacement compressor.

Japanese Laid-Open Patent Publication Nos. 10-205444 and 2001-173556 each disclose a variable displacement compressor in which refrigerant in a discharge chamber (discharge pressure zone) is supplied to a control pressure chamber through a supply passage, and refrigerant in the control pressure chamber is released to a suction pressure zone through a release passage, whereby the pressure in the control pressure chamber is adjusted. The pressure in the control pressure chamber is adjusted by changing the opening degree of an electromagnetic displacement control valve located in the supply passage. When the opening degree of the displacement control valve is increased, the flow rate of refrigerant supplied from the discharge chamber to the control pressure chamber is increased, so that the pressure in the control pressure chamber increases. This reduces inclination angle of a swash plate, so that the compressor displacement decreases. In contrast, when the opening degree of the displacement control valve is reduced, the flow rate of refrigerant supplied from the discharge chamber to the control pressure chamber is decreased, so that the pressure in the control pressure chamber is lowered. This increases the inclination angle of the swash plate, so that the compressor displacement increases.

In the above described electromagnetic displacement control valve, a fixed core attracts a movable core when a current is supplied to a solenoid coil, and a valve body, to which the movable core is coupled, is moved toward a position for closing a valve hole. When no current is supplied to the solenoid coil, an operating rod fixed to the movable core or the movable core itself contacts a bottom wall of a cylindrical container that accommodates the movable core.

When a vibration reaches the movable core and the valve body, the movable core and the valve body vibrate in the moving direction, thereby changing the opening degree of the electromagnetic displacement control valve. Specifically, when the opening degree of the displacement control valve is maximum, that is, when the operating rod or the movable core is contacting the bottom wall of the cylindrical container, the opening degree of the displacement control valve fluctuates between the maximum opening degree and a smaller opening degree. If the opening degree of the displacement control valve falls below the maximum opening degree, the flow rate of refrigerant sent from the discharge chamber to the control pressure chamber through the supply passage is reduced.

The clutchless type compressor disclosed in Japanese Laid-Open Patent Publication No. 10-205444 is mounted on a vehicle, and has swash plate that is always rotated while the vehicle engine is running. Thus, when deactivating the cooling operation, the inclination angle of the swash plate needs to be reliably minimized. However, in the conventional electromagnetic displacement control valves, if the valve body vibrates when the opening degree is maximum, the flow rate of refrigerant sent to the control pressure chamber is reduced, which can increase the inclination angle of the swash plate.

### SUMMARY OF THE INVENTION

Accordingly, it is an objective of the present invention to provide an electromagnetic displacement control valve in a clutchless type variable displacement compressor, which control valve is capable of maintaining the inclination angle of a swash plate even if the flow rate of refrigerant sent to a control pressure chamber fluctuates due to vibration of a valve body when no current is being supplied to the electromagnetic displacement control valve.

To achieve the forgoing objective and in accordance with one aspect of the present invention, an electromagnetic displacement control valve in a clutchless type variable displacement compressor, the displacement of which is controlled in accordance with a pressure in a control pressure chamber, is provided. The compressor has a supply passage for supplying refrigerant in a discharge pressure zone to the control pressure chamber, and a release passage for releasing refrigerant in the control pressure chamber to a suction pressure zone. The control valve includes a valve body, an electromagnetic driving device, an elastic urging member, and a counter urging member. The valve body is capable of opening and closing a valve hole that forms a part of the supply passage. The electromagnetic driving device is capable of driving the valve body toward a position for closing the valve hole. The elastic urging member is capable of urging the valve body toward the position for closing the valve hole. The counter urging member is capable of urging the valve body in a direction away from the position for closing the valve hole against an elastic urging force of the elastic urging member. In a state where no current is supplied to the electromagnetic driving device, the valve body is allowed to move in a direction away from the position for closing the valve hole against the elastic urging force of the elastic urging member.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional side view showing a whole variable displacement compressor according to a first embodiment of the present invention;

FIGS. 2A and 2B are enlarged cross-sectional side views showing the electromagnetic displacement control valve installed in the compressor of FIG. 1; and

FIG. 3 is an enlarged cross-sectional side view showing an electromagnetic displacement control valve according to a second embodiment of the present invention.

### DETAILED DESCRIPTION OF THE PREFERRED EMBODIMENTS

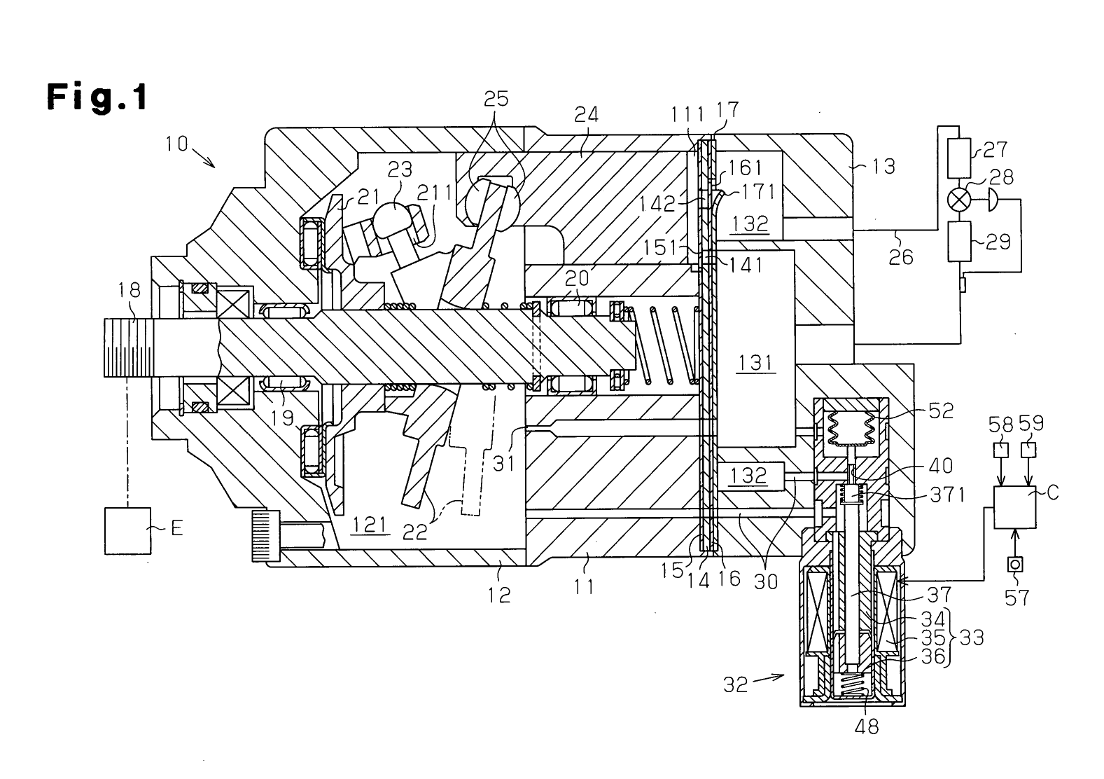

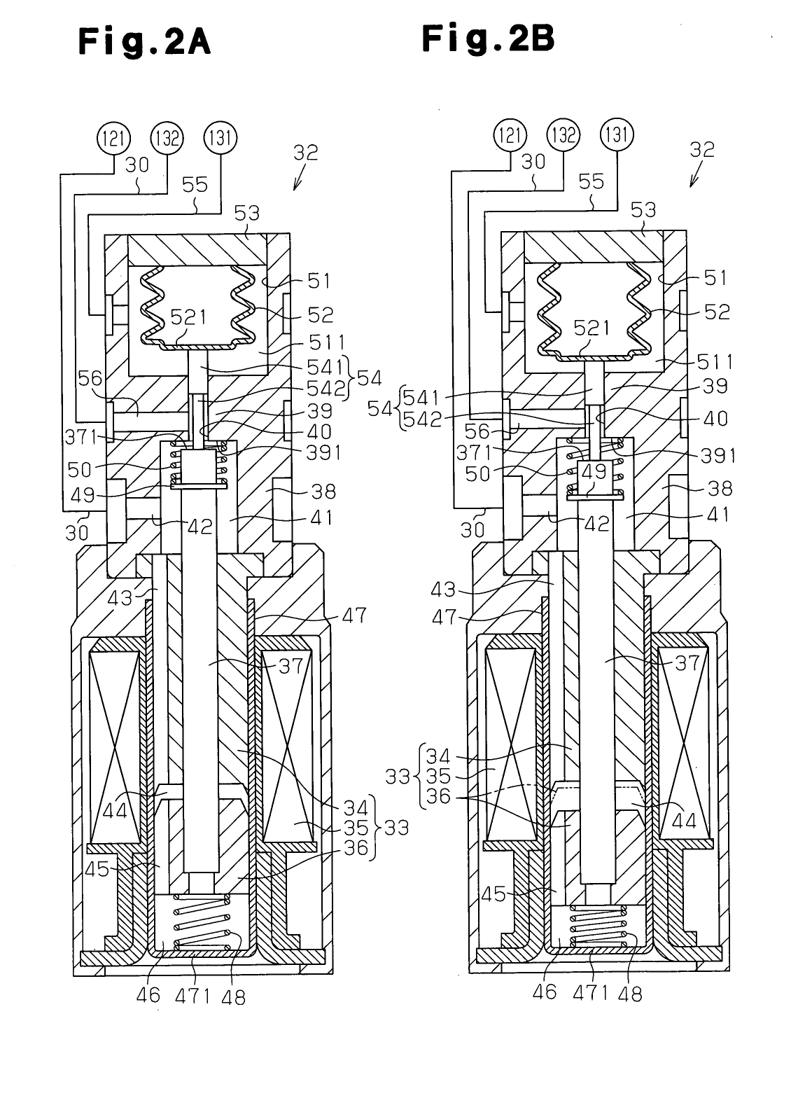

A first embodiment of the present invention will now be described with reference to FIGS. 1 to 2B.

As shown in FIG. 1, the housing of a variable displacement compressor 10 includes a cylinder block 11, a front housing member 12, and a rear housing member 13. The front housing member 12 is secured to the front end of the cylinder block 11, and the rear housing member 13 is secured to the rear end of the cylinder block 11 with a valve plate 14, valve flap plates 15, 16, and a retainer plate 17 arranged in between. The cylinder block 11, the front housing member 12, and the rear housing member 13 form the housing of the compressor 10. The compressor 10 forms a part of an air conditioner mounted, for example, on a vehicle.

The front housing member 12 and the cylinder block 11 define a control pressure chamber 121. The front housing member 12 and the cylinder block 11 rotatably support a rotary shaft 18 by means of radial bearings 19, 20. The rotary shaft 18 protrudes to the outside from the control pressure chamber 121, and receives power from a vehicle engine E, which is an external driving source to rotate, via a drive force transmission mechanism (not shown). When the vehicle engine E is running, the rotary shaft 18 always receives rotational drive force from the vehicle engine E.

A rotary support 21 is fixed to the rotary shaft 18, and a swash plate 22 is supported on the rotary shaft 18. The swash plate 22 is permitted to incline with respect to and slide along the rotary shaft 18. A pair of guide holes 211 are formed in the rotary support 21, and a pair of guide pins 23 are formed on the swash plate 22. The guide pins 23 are slidably fitted in the guide holes 211. The engagement of the guide holes 211 with the guide pins 23 allows the swash plate 22 to move along the axial direction of the rotary shaft 18 while being inclined, and to rotate together with the rotary shaft 18. The swash plate 22 is inclined by sliding the guide pins 23 with respect to the guide holes 211, and sliding the swash plate 22 with respect to the rotary shaft 18.

When a radial center portion of the swash plate 22 moves toward the rotary support 21, the inclination of the swash plate 22 increases. The maximum inclination angle of the swash plate 22 is defined by the contact between the rotary support 21 and the swash plate 22. When in a position indicated by solid lines in FIG. 1, the swash plate 22 is at the maximum inclination position. When in a position indicated by chain lines, the swash plate 22 is at the minimum inclination position.

Cylinder bores 111 extend through the cylinder block 11. Each cylinder bore 111 accommodates a piston 24. The rotation of the swash plate 22 is converted to reciprocation of the pistons 24 by means of shoes 25. Thus, each piston 24 reciprocates in the corresponding cylinder bore 111.

A suction chamber 131 and a discharge chamber 132 are defined in the rear housing member 13. The suction chamber 131 is a suction pressure zone, and the discharge chamber 132 is a discharge pressure zone. Suction ports 141 are formed in the valve plate 14, the valve flap plate 16, and the retainer plate 17. Each suction port 141 corresponds to one of the cylinder bores 111. Discharge ports 142 are formed in the valve plate 14 and the valve flap plate 15. Each discharge port 142 corresponds to one of the cylinder bores 111. Suction valve flaps 151 are formed on the valve flap plate 15. Each suction valve flap 151 corresponds to one of the suction ports 141. Discharge valve flaps 161 are formed on the valve flap plate 16. Each discharge valve flap 161 corresponds to one of the discharge ports 142. As each piston 24 moves from the top dead center to the bottom dead center (from the right side to the left side in FIG. 1), refrigerant in the suction chamber 131 is drawn into the associated cylinder bore 111 through the corresponding suction port 141 while flexing the suction valve flap 151. When each piston 24 moves from the bottom dead center to the top dead center (from the left side to the right side in FIG. 1), gaseous refrigerant in the corresponding cylinder bore 111 is discharged to the discharge chamber 132 through the corresponding discharge port 142 while flexing the discharge valve flap 161. The retainer plate 17 includes retainers 171, which correspond to the discharge valve flaps 161. Each retainer 171 restricts the opening degree of the corresponding discharge valve flap 161.

The suction chamber 131 is connected to the discharge chamber 132 by an external refrigerant circuit 26 located outside of the compressor 10. Refrigerant that is discharged from the discharge chamber 132 flows out to the external refrigerant circuit 26. A heat exchanger 27 for drawing heat from the refrigerant, an expansion valve 28, and a heat exchanger 29 for transferring the ambient heat to the refrigerant are located on the external refrigerant circuit 26. The expansion valve 28 controls the flow rate of refrigerant in accordance with fluctuations of gas temperature at the outlet of the heat exchanger 29. After being discharged to the external refrigerant circuit 26, the refrigerant flows into the suction chamber 131.

The discharge chamber 132 is connected to the control pressure chamber 121 with a supply passage 30. The control pressure chamber 121 is connected to the suction chamber 131 with a release passage 31. Refrigerant in the control pressure chamber 121 flows to the suction chamber 131 through the release passage 31. An electromagnetic displacement control valve 32 is installed in the rear housing member 13. The electromagnetic displacement control valve 32 regulates the cross-sectional area of the supply passage 30.

As shown in FIG. 2A and FIG. 2B, an electromagnetic driving device 33 of the electromagnetic displacement control valve 32 includes a fixed core 34, a solenoid coil 35, and a movable core 36. When a current is supplied to the solenoid coil 35, the fixed core 34 is excited and attracts the movable core 36. A part of the fixed core 34 is located in a cylindrical container 47 having a bottom. The movable core 36 is accommodated in the container 47. The supply of current to the electromagnetic driving device 33 is controlled by a control computer C shown in FIG. 1. In the present embodiment, the control computer C performs duty cycle control on the electromagnetic driving device 33. A transmission rod 37, which is an auxiliary member, is fixed to the movable core 36.

A valve housing 38, which forms the electromagnetic displacement control valve 32, includes a valve hole forming portion 39, in which a valve hole 40 is formed. A chamber 41 is defined between the valve hole forming portion 39 and the fixed core 34. The valve hole 40 communicates with the chamber 41. The chamber 41 is connected to the control pressure chamber 121 through a passage 42 and the supply passage 30. The valve hole 40 is connected to the discharge chamber 132 through a passage 56 and the supply passage 30.

The chamber 41 is connected to a space 44 between the movable core 36 and the fixed core 34 through a passage 43. The chamber 41 is also connected to a back pressure space 46 between the movable core 36 and a bottom wall 471 of the container 47 through the passages 43, 45. That is, the pressure in the control pressure chamber 121 (control pressure) is applied to the back pressure space 46 through the chamber 41 and the passages 43, 45.

A buffer spring 48 is located between the movable core 36 and the bottom wall 471 in the back pressure space 46. The buffer spring 48, which functions as a spring member (elastic urging member), contacts the movable core 36 and the bottom wall 471. The force (elastic urging force) of the buffer spring 48 urges the movable core 36 toward the fixed core 34.

A valve body 371 is integrally formed with the transmission rod 37. The valve body 371 contacts and separates from a seat surface 391 of the valve hole forming portion 39, thereby closing and opening the valve hole 40. A spring seat 49 is attached to a portion of the transmission rod 37 that is located in the chamber 41. An urging spring 50, which functions as a counter urging member, is located between the spring seat 49 and the valve hole forming portion 39. The force of the urging spring 50 and the force of the buffer spring 48 act against each other with the movable core 36 and the transmission rod 37 in between. The transmission rod 37 is urged by the force of the urging spring 50 in a direction moving the movable core 36 away from the fixed core 34 (in a direction to move the valve body 371 away from a position for closing the valve hole 40).

An accommodation chamber 51 formed in the valve housing 38 accommodates a bellows 52. A fixed end of the bellows 52 is coupled to an end wall 53, which is part of the valve housing 38. The bellows 52 defines a pressure sensing chamber 511 in the accommodation chamber 51. A movable end 521 of the bellows 52 is secured to a passive rod 54. The passive rod 54 has a large diameter portion 541 contacting the bellows 52 and a small diameter portion 542 coupled to the large diameter portion 541. The passive rod 54 is configured such that a distal end of the small diameter portion 542 contacts the valve body 371, and that a part of the large diameter portion 541 is located in the valve hole 40. As the transmission rod 37 moves, the passive rod 54 is moved integrally with the transmission rod 37, while contacting the transmission rod 37.

The large diameter portion 541 of the passive rod 54 disconnects the valve hole 40 and the pressure sensing chamber 511 from each other, so that the pressure (discharge pressure) in the discharge chamber 132 is not applied to the pressure sensing chamber 511 through the supply passage 30, the passage 56, and the valve hole 40.

The pressure sensing chamber 511 communicates with the suction chamber 131 through a passage 55. The pressure in the pressure sensing chamber 511 acts on the bellows 52 to contract the bellows 52. The pressure sensing chamber 511 is a pressure zone exposed to the pressure (suction pressure) in the suction chamber 131. As the suction pressure increases, the bellows 52 is contracted by a greater degree. That is, when the suction pressure increases, the valve body 371 is moved toward a position for closing the valve hole 40, so that the opening degree of the displacement control valve 32 is reduced. Accordingly, the flow rate of refrigerant supplied from the discharge chamber 132 to the control pressure chamber 121 is reduced, so that the pressure in the control pressure chamber 121 is decreased. When the suction pressure is lowered, the valve body 371 is moved away the position for closing the valve hole 40, so that the opening degree of the displacement control valve 32 is increased. Accordingly, the flow rate of refrigerant supplied from the discharge chamber 132 to the control pressure chamber 121 is increased, so that the pressure in the control pressure chamber 121 is increased. The degree of opening of the valve hole 40 is determined by the driving force generated by the electromagnetic driving device 33, the force of the buffer spring 48, the force of the urging spring 50, and the suction pressure supplied to the pressure sensing chamber 511.

The control computer C shown in FIG. 1 permits and stops supply of current to the electromagnetic driving device 33 in response to turning ON and OFF of an air-conditioner switch 57. The control computer C is connected to a compartment temperature setting device 58 and a compartment temperature sensor 59. When the air-conditioner switch 57 is ON, the control computer C controls current supplied to the electromagnetic driving device 33 based on the difference between a target compartment temperature set by the compartment temperature setting device 58 and the temperature detected by the compartment temperature sensor 59. If the duty cycle is increased, the transmission rod 37 (the valve body 371) is displaced from the chamber 41 toward the valve hole 40.

FIG. 1 illustrates a state in which the maximized current is being supplied to the electromagnetic driving device 33, and the valve body 371 closes the valve hole 40. In this state, the flow rate of refrigerant supplied from the discharge chamber 132 to the control pressure chamber 121 through the supply passage 30 is zero, and the refrigerant in the control pressure chamber 121 flows out to the suction chamber 131 via the release passage 31. This lowers the pressure in the control pressure chamber 121, and the inclination angle of the swash plate 22 is maximized. In this state, the stroke of the pistons 24 is maximized, and the compressor displacement is maximal.

When the current supplied to the electromagnetic driving device 33 is less than the maximized value, the valve hole 40 is open. In this state, although refrigerant is supplied from the discharge chamber 132 to the control pressure chamber 121 through the supply passage 30, the inclination angle of the swash plate 22 is smaller than the maximal inclination angle.

In the state shown in FIG. 2A, the current supply to the electromagnetic driving device 33 is stopped, and the valve hole 40 is widely open. In this state, refrigerant is supplied from the discharge chamber 132 to the control pressure chamber 121 through the supply passage 30, and the inclination angle of the swash plate 22 is minimized. The electromagnetic displacement control valve 32 is a normally open electromagnetic displacement control valve, in which the valve hole 40 is open when no current is supplied to the electromagnetic driving device 33.

FIG. 2A shows a state in which the current supply to the electromagnetic driving device 33 is stopped, and the movable core 36 and the transmission rod 37 are not vibrated. FIG. 2B shows a state in which the current supply to the electromagnetic driving device 33 is stopped, and the movable core 36 and the transmission rod 37 are vibrated. The movable core 36 shown by solid lines in FIG. 2B is at a position shifted, due to vibration, in a direction to contract the buffer spring 48 from a proper position of the movable core 36 in a state where the movable core 36 and the transmission rod 37 are not vibrated. The movable core 36 shown by chain lines is at a position shifted, due to vibration, in a direction to expand the buffer spring 48 from the proper position of the movable core 36 in a state where the movable core 36 and the transmission rod 37 are not vibrated.

The first embodiment provides the following advantages.

(1) When the valve body 371 is at a position other than the position for closing the valve hole 40, the valve body 371 can be moved by vibration in a direction toward the position for closing the valve hole 40 and a direction away from the position for closing the valve hole 40. If the valve body 371 is moved toward the position for closing the valve hole 40 from the normal position at the time when the valve body 371 and the transmission rod 37 are not vibrated, the flow rate of refrigerant supplied from the discharge chamber 132 to the control pressure chamber 121 via the displacement control valve 32 is reduced. Contrastingly, if the valve body 371 is moved away from the normal position at the time when the valve body 371 and the transmission rod 37 are not vibrated, the flow rate of refrigerant supplied from the discharge chamber 132 to the control pressure chamber 121 via the displacement control valve 32 is increased. The amount of increase of the refrigerant flow rate due to vibration of the valve body 371 is substantially the same as the amount of decrease of the refrigerant flow rate due to the vibration of the valve body 371. That is, the time-averaged value in a period of vibration of the increase and decrease of the refrigerant flow rate due to vibration of the valve body 371 is substantially zero. As a result, even if the movable core 36 and the transmission rod 37 are vibrated, the inclination angle of the swash plate 22 at the time when no current is supplied to the electromagnetic driving device 33 is not changed by the vibration of the valve body 371, and the inclination angle of the swash plate 22 of the compressor 10 is maintained at the minimum.

(2) If the force of the urging spring 50 is increased, vibration of the movable core 36 and the transmission rod 37 can be suppressed. In such a case, however, to drive the transmission rod 37 (that is, the valve body 371), it is necessary to increase the current supplied to the electromagnetic driving device 33 so that the driving force of the device 33 is increased in accordance with the increase of the force of the urging spring 50. In the present embodiment, it is unnecessary to increase the force of the urging spring 50 for suppressing vibration of the movable core 36 and the transmission rod 37. Thus, a low current can be used to actuate the transmission rod 37 (the valve body 371).

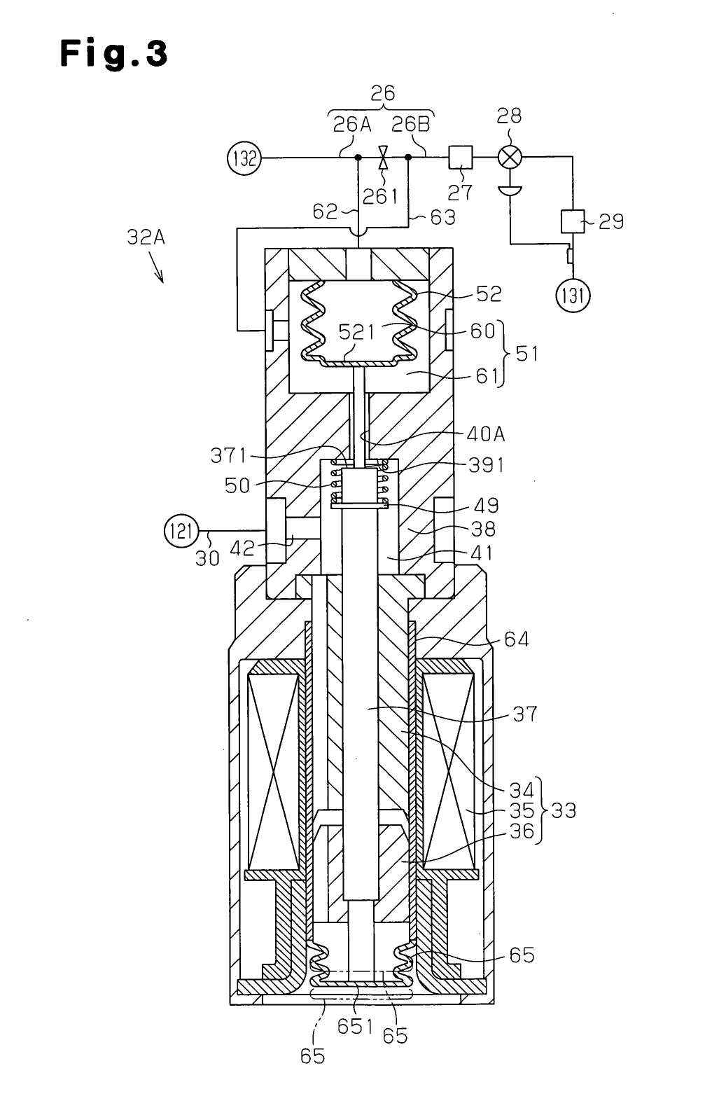

A second embodiment according to the present invention will now be described with reference to FIG. 3. Same reference numerals are used for those components which are the same as the corresponding components of the first embodiment.

An accommodation chamber 51 in the electromagnetic displacement control valve 32A is divided into a first pressure sensing chamber 60 and a second pressure sensing chamber 61 by a bellows 52. The first pressure sensing chamber 60 communicates with a section of an external refrigerant circuit 26A, which is upstream of a constriction 261, through a pressure introducing passage 62. The second pressure sensing chamber 61 communicates with a section of an external refrigerant circuit 26B, which is downstream of the constriction 261, through a pressure introducing passage 63. That is, the first pressure sensing chamber 60 is a zone the pressure in which is equal to that in a section of the external refrigerant circuit 26A that is upstream of the constriction 261. The second pressure sensing chamber 61 is a zone the pressure in which is equal to that in a section of the external refrigerant circuit 26B that is downstream of the constriction 261 and upstream of the heat exchanger 27. The pressure in the first pressure sensing chamber 60 and the pressure in the second pressure sensing chamber 61 oppose each other with the bellows 52 in between. The second pressure sensing chamber 61 is connected to a chamber 41 through a valve hole 40A. When the valve hole 40A is open, the refrigerant in the second pressure sensing chamber 61 can flow into the control pressure chamber 121.

When refrigerant is flowing through the external refrigerant circuits 26A, 26B, the pressure in the section of the external refrigerant circuit 26A that is upstream of the constriction 261 becomes higher than the pressure in the section of the external refrigerant circuit 26B that is downstream of the constriction 261 and upstream of the heat exchanger 27. When the flow rate of refrigerant in each of the external refrigerant circuits 26A, 26B (discharge pressure zone) increases, the pressure difference between the external refrigerant circuits 26A, 26B, or the pressure difference between both sides of the constriction 261, is increased. When the flow rate of refrigerant in each of the external refrigerant circuits 26A, 26B is decreased, the pressure difference between the external refrigerant circuits 26A, 26B, or the pressure difference between both sides of the constriction 261, is reduced. When the pressure difference between the sections on both sides of the constriction 261 is increased, the pressure difference between the pressure sensing chambers 60, 61 is increased. When the pressure difference between the sections on both sides of the constriction 261 is reduced, the pressure difference between the pressure sensing chambers 60, 61 is reduced. In accordance with the pressure difference between the pressure sensing chambers 60, 61, the force urging the transmission rod 37 away from the valve hole 40A is changed.

The degree of opening of the valve hole 40A is determined by the driving force generated by the electromagnetic driving device 33, the force of a bellows 65, the force of the urging spring 50, and the pressure difference between the pressure sensing chambers 60, 61.

The movable core 36 is accommodated in a cylindrical container 64. The container 64 is coupled to the bellows 65, which functions as an elastic urging member. The lower end of the transmission rod 37 contacts the inner surface of a movable end 651 of the bellows 65. When the movable core 36 and the transmission rod 37 are vibrated, the movable end 651 of the bellows 65 is vibrated integrally with the transmission rod 37 while contacting the rod 37, so that the bellows 65 is contracted.

When no current is supplied to the electromagnetic driving device 33, while the movable core 36 and the transmission rod 37 are not vibrated, the bellows 65 is at a position shown by solid lines in FIG. 3. When moved due to vibration from the position at the time when the movable core 36 and the transmission rod 37 are not vibrated, the bellows 65 is at a position shown by chain line in FIG. 3.

The second embodiment has the same advantages as the first embodiment.

It should be apparent to those skilled in the art that the present invention may be embodied in many other specific forms without departing from the spirit or scope of the invention. Particularly, it should be understood that the invention may be embodied in the following forms.

The coil-shaped buffer spring 48 may be replaced by an elastic body such as a disc spring or a rubber member.

Instead of providing the buffer spring 48, the fixed core 34 and the movable core 36 may be connected to each other by a tension spring. The tension spring pulls the movable core 36 toward the fixed core 34. When no current is supplied to the electromagnetic driving device 33, the tension spring allows the movable core 36 and the transmission rod 37 to move both toward and away from the valve hole 40 from proper positions.

The valve body 371 and the transmission rod 37 may be formed separately.

The present examples and embodiments are to be considered as illustrative and not restrictive and the invention is not to be limited to the details given herein, but may be modified within the scope and equivalence of the appended claims.

1. An electromagnetic displacement control valve in a clutchless type variable displacement compressor, the displacement of which is controlled in accordance with a pressure in a control pressure chamber, wherein the compressor has a supply passage for supplying refrigerant in a discharge pressure zone to the control pressure chamber, and a release passage for releasing refrigerant in the control pressure chamber to a suction pressure zone, the control valve comprising:
a valve body capable of opening and closing a valve hole that forms a part of the supply passage;
an electromagnetic driving device capable of driving the valve body toward a position for closing the valve hole;
an elastic urging member capable of urging the valve body toward the position for closing the valve hole; and
a counter urging member capable of urging the valve body in a direction away from the position for closing the valve hole against an elastic urging force of the elastic urging member,
wherein, in a state where no current is supplied to the electromagnetic driving device, the valve body is allowed to move in a direction away from the position for closing the valve hole against the elastic urging force of the elastic urging member.

2. The control valve according to claim 1, wherein the electromagnetic driving device has a movable core and a fixed core, wherein an auxiliary member is either integrally formed with the valve body or coupled to the valve body to be capable of moving integrally with the valve body, and wherein the elastic urging member contacts either the movable core or the auxiliary member, and urges the auxiliary member in a direction from the movable core toward the fixed core.

3. The control valve according to claim 2, wherein the movable core is accommodated in a cylindrical container having a bottom wall, and wherein the elastic urging member is a spring member that is provided between the bottom wall of the container and the movable core so as to contact the movable core.

4. The control valve according to claim 2, wherein the elastic urging member is a bellows contacting the auxiliary member.

5. The control valve according to claims 1, wherein the counter urging member is a spring member that acts against the drive force of the electromagnetic driving device.
